(19) United States
(12) Patent Application Publication
(10) Pub. No.: US 2026/0178937 A1
(43) Pub. Date: Jun. 25, 2026

(54) USING MACHINE-LEARNING MODEL TO PREDICT PERCEPTION ABOUT AN EXPIRATION DATE OF ITEM

(71) Applicant: Maplebear Inc., San Francisco, CA (US)

(72) Inventors: Naval Shah, Toronto (CA); Brent Scheibelhut, Toronto (CA); Hua Xiao, Toronto (CA); Amalia Rothschild-Keita, Berkeley, CA (US); Mark Oberemk, Toronto (CA); Akshay Bagai, Oakville (CA)

(21) Appl. No.: 18/990,866

(22) Filed: Dec. 20, 2024

(51) Int. Cl. G06N 5/022

(52) U.S. Cl. CPC G06N 5/022

(57) ABSTRACT

An online system uses a trained machine-learning model to predict a perception of a user about an expiration date of an item. Upon receiving an item signal including information about the expiration date, the online system applies the machine-learning model to the item signal, information about the user, and information about the item to generate a perception score indicative of a likelihood that the user will perceive the expiration date as unacceptable. Based on the perception score and the information about the item, the online system identifies a second item for replacing the item, the second item having a second expiration date that is later than the expiration date. The online system generates, using information about the item and the second item, a user interface signal that causes a user interface to display a notification about the expiration date and a recommendation for replacing the item with the second item.

### BACKGROUND

An online system allows their users to browse and acquire items by placing online orders, where the items are provided by sources (e.g., retailers) associated with the online system. In the current online delivery services, a significant challenge arises when users receive items that have expirations dates that the users perceive as “too soon.” This perception can negatively impact user satisfaction, brand perception, source inventory, and values of servicing agents (e.g., pickers) that pick and deliver items to users. Users may be unhappy with items that may not last as long as expected, leading to potential grievances and diminished trust in the online delivery services. Sources may face increased pressure to manage inventory effectively while risking loss of sales due to potential removal of unsatisfactory items. For consumer-packaged goods (CPG) entities, there is a potential damage to brand reputation if users repeatedly associate their products with short viability. And pickers may be unintentionally involved in incorrect item selections, leading to inefficient delivery experiences and possible negative feedback from users. All or at least some of these can result in increased rates of refunds and appeasements, which may in turn incur higher costs for online system platforms and sources while negatively impacting user satisfaction.

Therefore, there is a need to predict, before picking and delivery, whether an expiration date of an item is too short. This prediction should be personalized for a given user and specific to a type of the item, since the perception of “too soon” expiration date can vary by user and by item.

### SUMMARY

Embodiments of the present disclosure are directed to using a trained machine-learning model of an online system to predict a perception of a user of the online system about an expiration date of an item.

In accordance with one or more aspects of the disclosure, the online system receives, via a network and from a device associated with a user of the online system or a device associated with a servicing agent who is servicing an order placed by the user at the online system, an item signal including information about an expiration date of an item in the order. Responsive to receiving the item signal, the online system accesses a perception prediction machine-learning model of the online system, wherein the perception prediction machine-learning model is trained to predict a likelihood that the user will perceive the expiration date of the item as unacceptable. The online system applies the perception prediction machine-learning model to the item signal, information about the user, and information about the item to generate a perception score that is indicative of the likelihood that the user will perceive the expiration date of the item as unacceptable. The online system identifies, based at least in part on the perception score and the information about the item, a second item for replacing the item, the second item having a second expiration date that is later than the expiration date of the item. The online system generates, using the information about the item and information about the second item, a user interface signal. The online system sends, via the network, the user interface signal to the device associated with the user or the device associated with the servicing agent, wherein the sending the user interface signal causes the device associated with the user or the device associated with the servicing agent to display a user interface with a notification about the expiration date of the item and a recommendation for replacing the item in the order with the second item.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example architectural flow diagram of using a trained machine-learning model of an online system to predict a perception of a user of the online system about an expiration date of an item, in accordance with one or more embodiments.

FIG. 4 is a flowchart for a method of using trained machine-learning models of an online system to predict a perception of a user of the online system about an expiration date of an item, in accordance with one or more embodiments, in accordance with one or more embodiments.

### DETAILED DESCRIPTION

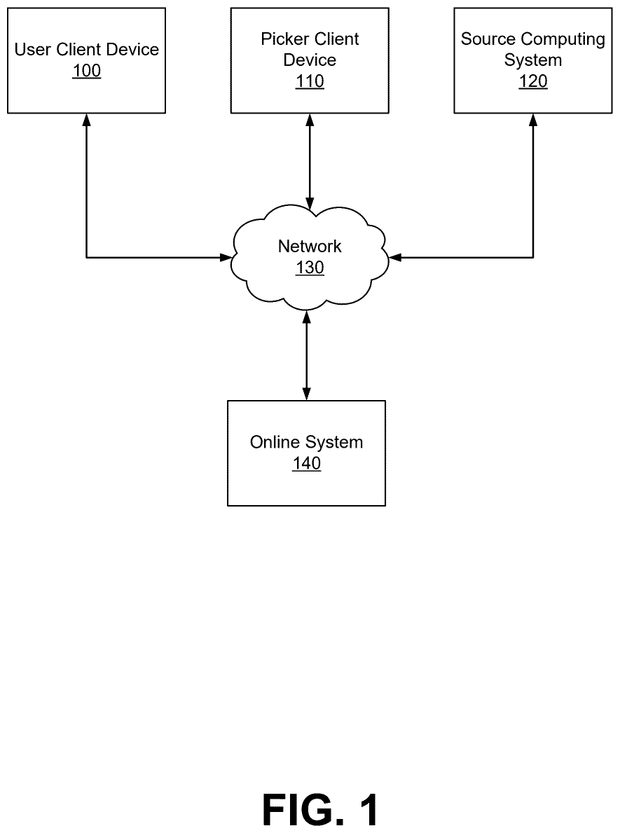

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker (i.e., fulfillment agent, servicing agent, or agent) that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a source location. The user's order may specify which groceries they want to be delivered from the source location and the quantities of each of the groceries. The user client device 100 transmits the user's order to the online system 140 and the online system 140 selects a picker to travel to the source location to collect the groceries ordered by the user. The online system transmits an offer to the picker for the picker to service the order in exchange for consideration and, if the picker accepts the offer, the picker collects the groceries from the source location. Once the picker has collected the groceries ordered by the user, the picker delivers the groceries to a location transmitted to the picker client device 110 by the online system 140.

The online system 140 assigns pickers to fulfill orders from users by picking items from source locations and delivering the items to the users. For items that are associated with expiration dates, the online system 140 avoids delivering items that are too close to their expiration dates using a machine-learning model that is trained to predict a user's perception of whether an expiration date of an item is unsatisfactory. When a picker is picking an item at a source location, the online system 140 ingests an expiration date associated with the item, such as from an image of the item or item scanning data. If the item is too close to its expiration and users will likely complain about that, as predicted by the machine-learning model, the online system 140 instructs the picker to select a different item, possibly a replacement if no other identical items have later expiration dates.

The online system 140 trains a machine-learning model to predict a user's perception of whether an expiration date of an item is unsatisfactory such that the trained machine-learning model is specific to the user and the item (or item type/category). The machine-learning model is thus trained to predict a likelihood of a user's dissatisfaction with an expiration date of an item. By analyzing various data inputs, the machine-learning model may anticipate scenarios where users might request refunds or express dissatisfactions with delivered items.

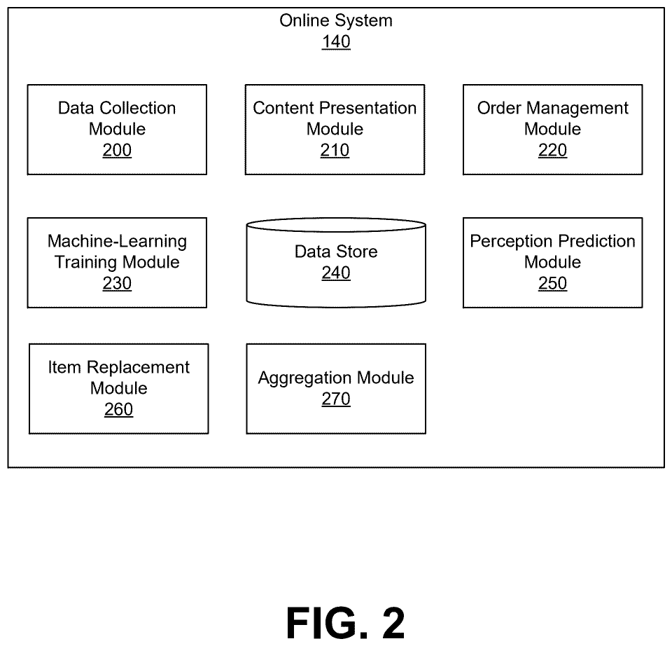

The online system 140 deploys the trained machine-learning model that leverages personalization signals to predict when a user is likely to find an item's expiration date unsatisfactory. By providing proactive prompts for users to request replacements if desired, the online system 140 aims to optimize the selection and delivery process. This preemptive approach applied by the online system 140 is designed to: (i) decrease appeasement and refund costs by minimizing refund requests and associated logistics; (ii) improve user satisfaction rates by ensuring higher-quality deliveries that meet expectations; (iii) enhance sources'inventory management capabilities through insightful data, encouraging quicker response times to restock or remove specific items; and (iv) increase the percentage of “good orders,” thereby boosting overall reliability and effectiveness of the online system 140. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a perception prediction module 250, an item replacement module 260, and an aggregation module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The perception prediction module 250 may access a perception prediction model (e.g., machine-learning model) that is trained to predict, for a given user of the online system 140 and an item (e.g., type of the item), a likelihood that the user will complain about an expiration date of the item. The perception prediction module 250 may deploy the perception prediction model to run a machine-learning algorithm to input signals to generate a perception score for a user-item pair that is indicative of a likelihood that the user will perceive an expiration date of the item as unacceptable. The perception score may have a value between 0 and 1, where a lower value of the perception score indicates a lower likelihood that the user will perceive the expiration date of the item as unacceptable, and a higher value of the perception score indicates a higher likelihood that the user will perceive the expiration date of the item as unacceptable. Hence, the perception score may represent the likelihood that a given item (or type of item), in the context of its expiration date and associated interactions, will lead to an appeasement request or negative feedback from a user, such as a poor picker rating or an unfavorable review of the item. A set of parameters for the perception prediction model may be stored at one or more non-transitory computer-readable media of the perception prediction module 250. Alternatively, the set of parameters for the perception prediction model may be stored at one or more non-transitory computer-readable media of the data store 240.

The perception prediction module 250 may ingest a variety of input signals into the perception prediction model so that the perception prediction model can infer a user's perception about an expiration date of an item. In providing the input signals to the perception prediction model, the perception prediction module 250 may provide user data including information about one or more features of the user, such as information about previous appeasement requests by the user, historical chats between the user and pickers, historical chats between the user and a support personnel of the online system 140, some other user-related information, or some combination thereof. The perception prediction module 250 may retrieve the user data from a user catalog database (e.g., stored at the data store 240).

To obtain the relevant user's chats for input into the perception prediction model, the perception prediction module 250 may parse message threads retrieved from the user catalog database to identify portions of the user's chats that are relevant to item expiration dates. For example, the perception prediction model may utilize exchanges between pickers and the user to assess user's sentiment around item expiration dates. The perception prediction model may analyze these interactions to understand if there were requests by the user to swap items or concerns expressed about item freshness. Similarly, the perception prediction model may utilize the exchanges between the user and the support personnel of the online system 140 to infer any negative sentiment by the user about any item-related issues, including expiration related issues that perhaps did not result in any appeasement.

In providing the input signals to the perception prediction model, the perception prediction module 250 may further provide source data with information about user's interactions at a source location with different types of items. The source data may be captured by one or more sensors (e.g., cameras) of the smart shopping cart employed by the user for shopping at the source location and then uploaded to the online system 140 and the perception prediction module 250 via the network 130. For example, by examining the history of items scanned and subsequently removed by the user from smart shopping carts, along with corresponding expiration dates, the perception prediction model may identify patterns indicating user's dissatisfaction or potential user's issues with item expiration dates.

In providing the input signals to the perception prediction model, the perception prediction module 250 may further provide item data including information about one or more features of the item, such as information about a type of the item, information about historical appeasements related to expirations of the item, actual days until the expiration date of the item, item metadata, some other item-related information, or some combination thereof. The perception prediction module 250 may retrieve the item data from an item catalog database (e.g., stored at the data store 240). For example, appeasement data with information about historical appeasement records of refund requests due to perceived premature item expirations may be utilized to refine the prediction accuracy and specificity of the perception prediction model. The item metadata may include detailed information on the item in question, associated expiration dates, and relevant user interactions that provide context to augment outputs of the perception prediction model with real-time user data.

The primary use case of the perception prediction model is predicting whether a user of the online system 140 will complain about an expiration date of an item, i.e., a personalized proactive management of item expiration concerns. For example, a picker can pick an item at a source location and take and an image of the item using the picker client device 110. A mobile application running on the picker client device 110 may extract an expiration date of the item from the image. Alternatively, the picker can manually input an expiration date of the item via a user interface of the picker client device 110. Upon the expiration date of the item is loaded at the online system 140, the perception prediction module 250 may deploy a machine-learning algorithm of the perception prediction model to generate a perception score that is indicative of a likelihood that the user will perceive the expiration date of the item as unacceptable. If the perception score is above a threshold score, the item replacement module 260 may trigger a replacement flow at the online system 140.

The replacement flow triggered by the item replacement module 260 may prompt the picker (e.g., via a user interface of the picker client device 110) to replace the item with the same item that has a later expiration date. If the same item having the later expiration date is unavailable at a source, the item replacement module 260 may prompt the picker to replace the item with another item of a same type that has a later expiration date and is available at the source. In one or more embodiments, instead of having a fixed threshold score that triggers the replacement flow, the item replacement module 260 computes a cost of the item replacement versus the cost of appeasement due to a user complaining about the expiration date of the item. If the cost of item replacement is less than the cost of appeasement, the item replacement module 260 triggers the replacement flow.

The personalized proactive management of item expiration concerns can be achieved through an intelligent alert system embedded within picker workflows and user shopping interfaces, such as smart shopping carts and in-store application list mode of the user client device 100. The intelligent alert system is designed to ensure that items meet user standards for freshness, thereby increasing user satisfaction and reducing refund requests associated with expiration dissatisfaction.

The picker, using the mobile interface of the picker client device 110, or a user with a smart shopping cart or the in-store application list mode of the user client device 100, scans an item intended for purchase. Expiration date information for the item may originate from various sources. In one or more embodiments, the expiration date information originates from inventory data or catalog data of the source computing system 120 available to the online system 140 via the network 130. In one or more other embodiments, one or more images of the item are fed into a machine-learning model of the online system 140 (e.g., a vision language model or multi-modal language model) to extract the expiration date for the item. In one or more other embodiments, the picker may input the expiration date of the item into their mobile application via a user interface of the picker client device 110 as the picker is picking the item.

The perception prediction model may then process inputs, such as item details, the expiration date of the item, and information about the user's historical preferences or behaviors to calculate a perception score (which is specific to the user and the item) that is indicative of a likelihood that the user will perceive the expiration date of the item as unacceptable. In one or more embodiments, in addition to being related to a specific item, the perception score generated by the perception prediction model is personalized only for a user. In one or more other embodiments, the perception prediction model is personalized for a (user, location) tuple to accommodate personalization across multiple delivery addresses, e.g., multiple homes, families, ordering for other family members, ordering for parents, etc.

If the perception score exceeds a threshold score, indicating a likely unsatisfactory expiration timeframe for the user, the item replacement module 260 may trigger a proactive alert signal that initiates the replacement flow traditionally reserved for scenarios when an item is unavailable. However, this time, the replacement flow is engaged for items deemed potentially unsuitable due to their expiration dates. The item replacement module 260 (or some other module of the online system 140) may prompt the picker or the user (if shopping themselves) to choose a course of action. Options may include confirming the original item or opting for an alternate item, which may involve sourcing the same product with a later expiration date if available. Users may be either directly prompted to make this decision in real-time, or their pre-determined shopping preferences can guide the user action seamlessly, embedding convenience and personalization into the process. By integrating this smart alert mechanism, the online system 140 enhances the user shopping experience, minimizes user dissatisfaction related to item freshness, and maintains high “good order” rates and lowers appeasement costs and user complaints.

Another use case of the perception prediction model is to determine, for a specific source (or source location), minimum acceptable expiration dates for different item types at the source. In this manner, the online system 140 may provide insights to the source about unacceptable expiration dates for various items at the source. For this purpose, the perception prediction module 250 may deploy the machine-learning algorithm of the perception prediction model for a plurality of users of the online system 140 and different item types. The perception prediction module 250 may sample users who visit and/or order items from a specific source (or source location). For a given user, the perception prediction module 250 may deploy the perception prediction model across various expiration days of different item types to infer a likelihood of the user complaining about an expiration date of each item type. Then, the perception prediction module 250 may apply a threshold (e.g., more than 80% chance of the user complaining) to infer the minimum expiration date that is acceptable for the user. The aggregation module 270 may aggregate, for each item type, the minimum acceptable expiration date across users. The aggregation module 270 may then generate a report signal with information about the aggregated minimum acceptable expiration dates across users and item types. The aggregation module 270 may send the report signal to the source computing system 120 via the network 130, thus providing insights to the source about minimum acceptable expiration dates for various items and item types at the source.

Thus, the online system 140 that integrates the perception prediction model has the ability to provide source location managers with predictive insights regarding items with high rates of expected user dissatisfaction due to their expiration dates. This can allow for proactive decision-making to enhance inventory management and user satisfaction. Source location managers may log into a source tooling platform of the online system 140 designed to provide comprehensive oversight of inventory health and user satisfaction metrics. The online system 140 may pre-generate predictive insights using the advanced machine-learning algorithm of the perception prediction model to evaluate all items currently on the source's shelves at the specific source location. These insights may highlight which items are likely to result in user dissatisfaction and loss of sales due to their proximity to expiration.

The perception prediction module 250 may compare each item's perception score generated by the perception prediction model and aggregated over a collection of users against a customizable threshold set by the source location manager. Items in the source location having the perception scores that exceed this threshold may be flagged for potential action. Once the items are flagged, the source location manager may receive (e.g., at the source computing system 120 via the network 130) a prompt generated by the aggregation module 280 with options to address the highlighted inventory issues. Upon receiving the prompt, the source location manager may choose to reduce prices of the flagged items, i.e., apply discounts to sell the flagged merchandise quickly. Alternatively, the source location manager may choose to restock, i.e., to refresh the shelfs with new inventory if available. In this manner, the online system 140 empowers source location managers to make informed decisions, reducing the risk of user dissatisfaction, optimizing turnover rates, and improving overall sales performance.

The machine-learning training module 230 may perform initial training of the perception prediction model using training data. The machine-learning training module 230 may generate the training data by retrieving, from the user catalog database, appeasement data for a collection of users of the online system 140 in relation to expiration dates of a collection of items delivered to the collection of users. Each label for the training data may include an indication about a particular appeasement for a specific item type and a specific time duration until an item expiration date. The machine-learning training module 230 may then train the perception prediction model using the training data to generate initial values for the set of parameters of the perception prediction model.

The machine-learning training module 230 may collect feedback data with information about an action performed by the user in response to a prompt to replace an item that has a “too soon” expiration date. The prompt may be displayed at a user interface of the smart shopping cart or a user interface of the user client device 100. The action performed by the user may be to replace the item with another item (e.g., identical to the original item or being of a same type as the original item) that has an expiration date that is later than the expiration date of the original item. Alternatively, the action performed by the user may be to proceed with conversion of the original item. The feedback data may be recorded at the user client device 100 and/or the smart shopping cart and communicated, via the network 130, to the online system 140 and the machine-learning training module 230. The machine-learning training module 230 may then re-train the perception prediction model by updating the set of parameters of the perception prediction model using the feedback data.

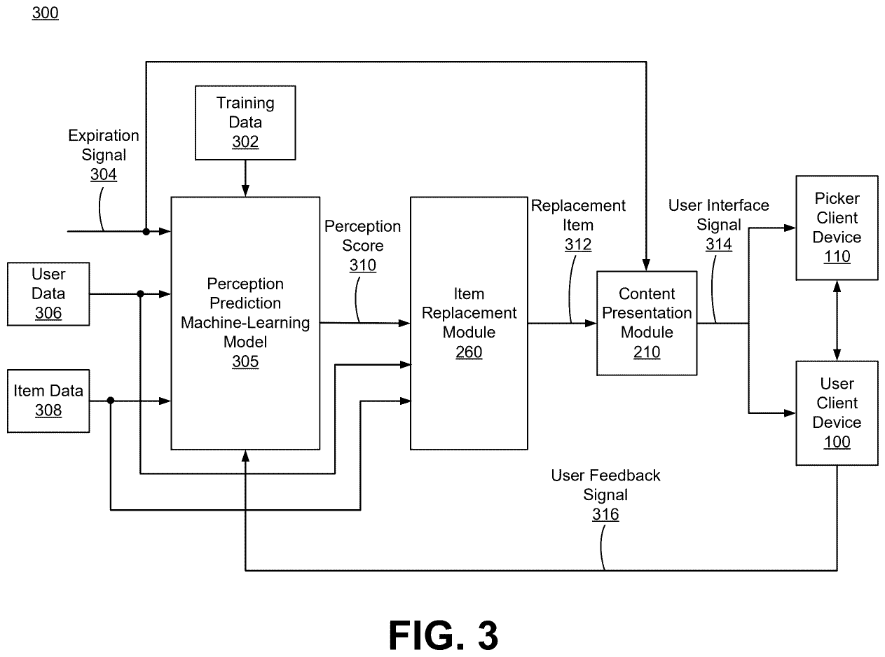

FIG. 3 illustrates an example architectural flow diagram 300 of using a perception prediction machine-learning model 305 of the online system 140 to predict a perception of a user of the online system 140 about an expiration date of an item, in accordance with one or more embodiments. Prior to running a machine-learning algorithm of the perception prediction machine-learning model 305, the online system 140 may perform (e.g., via the machine-learning training module 230) initial training of the perception prediction machine-learning model 305 using training data 302 to generate initial values for a set of parameters of the perception prediction machine-learning model 305. The machine-learning training module 230 may generate the training data 302 by retrieving, from the data store 240, appeasement data for a collection of users of the online system 140 in relation to expiration dates of a collection of item types delivered to the collection of users. The machine-learning training module 230 may generate a plurality of labels for the training data, each label including an indication about an appeasement for a corresponding item type of the collection of item types and an indication about a time duration from a date of the appeasement until a corresponding expiration date of the corresponding item type. After the training process is completed, the online system 140 may provide input signals to the perception prediction machine-learning model 305 (e.g., via the perception prediction module 250), such as an expiration signal 304, user data 306, and/or item data 308. Furthermore, the expiration signal 304 may be also passed to the content presentation module 210. Some additional inputs not shown in FIG. 3 may be further provided to the perception prediction machine-learning model 305.

The expiration signal 304 may include information about an expiration date of an item from an order placed by a user of the online system 140. The expiration signal 304 may originate from a signal received at the online system 140 (e.g., at the perception prediction module 250) from the picker client device 110, the smart shopping cart, or the user client device 100 via the network 130. In one or more embodiments, one or more cameras of the smart shopping cart operated by the user at a source location may capture image data related to the item. A computer system of the smart shopping cart may communicate the image data to the online system 140 and the perception prediction module 250 via the network 130. The perception prediction module 250 may then generate the expiration signal 304 by extracting the information about the expiration date of the item from the received image data.

Alternatively, a picker who is servicing the order may scan at a source the item via a mobile application of the picker client device 110 or take an image of the item via a camera of the picker client device 110. The scanned data (or image data) may be communicated from the picker client device 110 to the online system 140 and the perception prediction module 250 via the network 130. The perception prediction module 250 may then generate the expiration signal 304 by extracting the information about the expiration date of the item extracted from the received scanned data (or the received image data).

Alternatively, the user may utilize an in-store application of the user client device 100 when shopping at the source location. In such cases, the user may scan the item via the in-store application to generate scanned data for the item. The scanned data may be communicated from the user client device 100 to the online system 140 and the perception prediction module 250. The perception prediction module 250 may then generate the expiration signal 304 by extracting the information about the expiration date of the item from the received scanned data.

In providing the user data 306 to the perception prediction machine-learning model 305, the perception prediction module 250 may provide user's chat data related to expiration dates of the item and/or expiration dates of other items of a same type as the item, information about item replacements made by the user using smart shopping carts due to item expiration dates, information about user's previous appeasements (e.g., refunds) related to item expiration dates, information about user's replacement preferences, user's historical replacement data, some other user-related information, or some combination thereof. The perception prediction module 250 may retrieve the user data 306 from a user catalog database (e.g., part of the data store 240), or the perception prediction module 250 may derive the user data 306 from data retrieved from the user catalog database.

In providing the item data 308 to the perception prediction machine-learning model 305, the perception prediction module 250 may provide information about one or more features of the item, such as a taxonomy (i.e., classification) of the item, information about a type of the item, information about perishability of the item, information about historical appeasements related to expiration dates of the item, some other features of the item, or some combination thereof. The perception prediction module 250 may retrieve, using an identifier of the item, the item data 308 from an item catalog database (e.g., part of the data store 240), or may derive the item data 308 from data retrieved from the item catalog database.

The perception prediction machine-learning model 305 may apply the machine-learning algorithm to the expiration signal 304, the user data 306, and/or the item data 308 to generate a perception score 310 that is indicative of a likelihood that the user will perceive the expiration date of the item as unacceptable. The perception score 310 may have a value between 0 and 1, where a lower value of the perception score 310 indicates a lower likelihood that the user will perceive the expiration date of the item as unacceptable, and a higher value of the perception score 310 indicates a higher likelihood that the user will perceive the expiration date of the item as unacceptable. The perception prediction machine-learning model 305 may pass the perception score 310 for the user and the item to the item replacement module 260.

The item replacement module 260 may use the perception score 310, at least a portion of the user data 306 and/or at least a portion of the item data 308 to identify a replacement item 312 for replacing the original item in the order. The replacement item 312 may be identical to the item but having an expiration date that is later than the expiration date of the original item. Alternatively, the replacement item 312 may be different than the original item but have a same item type (e.g., item of a different brand, size and/or quantity than the original item) and an expiration date that is later than the expiration date of the original item. In one or more embodiments, the item replacement module 260 triggers a replacement flow if the perception score 310 is above a preconfigured threshold score, i.e., if it is likely that the user will complain about the expiration date of the original item. In such cases, the item replacement module 260 may identify the replacement item 312 and pass information about the replacement item 312 to the content presentation module 210. In one or more other embodiments, if the perception score 310 is above the threshold score, the item replacement module 260 computes a replacement cost related to a cost of replacing the original item with the replacement item 312, and the item replacement module 260 also computes an appeasement cost related to a cost of appeasement of the user due to the user complaining about the expiration date of the original item. If the replacement cost is less than the appeasement cost, the item replacement module 260 passes information about the replacement item 312 to the content presentation module 210.

The content presentation module 210 may generate a user interface signal 314 using the expiration signal 304 with the information about the expiration date of the original item and information about the replacement item 312 including the expiration date of the replacement item 312. The content presentation module 210 may communicate, via the network 130, the user interface signal 314 to the user client device 100, the smart shopping cart, or the picker client device 110. The user interface signal 314 may cause the user client device 100, the smart shopping cart, or the picker client device 110 to display a user interface with a notification about the expiration date of the original item and a recommendation for replacing the original item in the order with the replacement item that has a later expiration date. The picker who is servicing the order may communicate, via the network, this notification from the picker client device 110 to the user client device 100 so that the user can decide whether to proceed with the original item or to accept the recommendation to replace the original item with the replacement item 312.

The user client device 100 (or the smart shopping cart) may generate and record a user feedback signal 316 including information about an action performed by the user in response to the notification about the expiration date of the original item and the recommendation for replacing the original item in the order with the replacement item 312. In one or more embodiments, the user decides to ignore the notification about the expiration date of the original item and proceed with conversion of the original item. In one or more other embodiments, the user accepts (e.g., via a user interface element) the recommendation for replacing the original item in the order with the replacement item 312. The online system 140 may receive (e.g., via the machine-learning training module 230) the user feedback signal 316 from the user client device 100 (or the smart shopping cart) via the network 130. The machine-learning training module 230 may utilize the user feedback signal 316 to re-train the perception prediction machine-learning model 305. By utilizing user feedback signals 316 provided by various users over time, the machine-learning training module 230 may continuously update the set of parameters of the perception prediction machine-learning model 305 and continuously improve the machine-learning algorithm of the perception prediction machine-learning model 305.

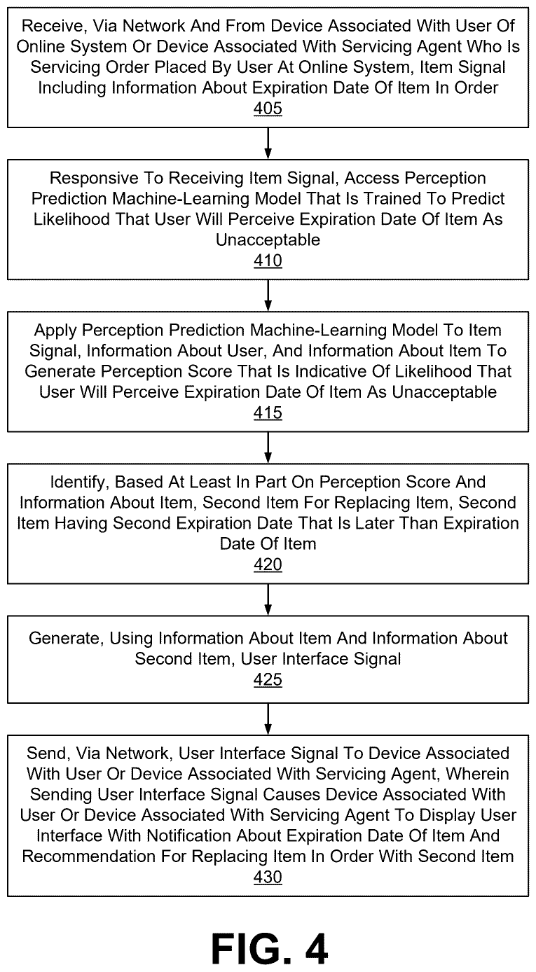

FIG. 4 is a flowchart for a method of using a trained machine-learning model of an online system to predict a perception of a user of the online system about an expiration date of an item, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 receives 405 (e.g., at the perception prediction module 250), via a network (e.g., the network 130) and from a device associated with a user of the online system 140 (e.g., the user client device 100 or a smart shopping cart) or a device associated with a servicing agent (e.g., the picker client device 110) who is servicing an order placed by the user at the online system 140, an item signal including information about an expiration date of an item in the order. The online system 140 may gather, via one or more cameras mounted to the device associated with the user being a physical cart (e.g., smart shopping cart) operated by the user in a source location, image data related to the item. The online system 140 may receive (e.g., at the perception prediction module 250), from the physical cart and via the network, the image data. The online system 140 may extract (e.g., via the perception prediction module 250), from the image data, the expiration date of the item to obtain the item signal including the information about the expiration date of the item.

The online system 140 may receive (e.g., at the perception prediction module 250), from the device associated with the servicing agent and via the network, scanning data generated by scanning the item via the device associated with the servicing agent. The online system 140 may extract (e.g., via the perception prediction module 250), from the scanning data, the expiration date of the item to obtain the item signal including the information about the expiration date of the item.

The online system 140 may receive (e.g., at the perception prediction module 250), from the device associated with the servicing agent and via the network, image data related to the item captured by a camera of the device associated with the servicing agent. The online system 140 may extract (e.g., via the perception prediction module 250), from the image data, the expiration date of the item to obtain the item signal including the information about the expiration date of the item.

Responsive to receiving the item signal, the online system 140 accesses 410 a perception prediction machine-learning model of the online system 140 (e.g., via the perception prediction module 250), wherein the perception prediction machine-learning model is trained to predict a likelihood that the user will perceive the expiration date of the item as unacceptable. The online system 140 applies 415 the perception prediction machine-learning model (e.g., via the perception prediction module 250) to the item signal, information about the user, and information about the item to generate a perception score that is indicative of the likelihood that the user will perceive the expiration date of the item as unacceptable.

The online system 140 may retrieve (e.g., via the perception prediction module 250), from a database of the online system 140 (e.g., the data store 240), message threads related to chats of the user. The online system 140 may generate (e.g., via the perception prediction module 250) the information about the user by parsing the message threads to extract portions of the message threads related to at least one of expiration dates of the item or expiration dates of one or more other items of a same type as the item, the information about the user including the extracted portions of the message threads.

The online system 140 may gather, via sensors mounted to physical carts (e.g., smart shopping carts) operated by the user in source locations, sensor data including information about a first set of expiration dates of a first set of items placed to the physical carts and later replaced by a second set of items having a second set of expiration dates. The online system 140 may receive (e.g., at the order management module 220), from the physical carts and via the network, the sensor data. The online system 140 may store (e.g., via the order management module 220), in the database, the sensor data. The online system 140 may retrieve (e.g., via the perception prediction module 250), from the database, the sensor data to generate the information about the user including the sensor data. The online system 140 may further retrieve, from the database and using an identifier of the item, the information about the item including information about a type of the item and information about historical appeasements related to expirations of the item.

The online system 140 identifies 420 (e.g., via the item replacement module 260), based at least in part on the perception score and the information about the item, a second item for replacing the item, the second item having a second expiration date that is later than the expiration date of the item. The online system 140 may compare (e.g., via the item replacement module 260) the perception score to a threshold score. Responsive to the perception score being above the threshold score, the online system 140 may identify (e.g., via the item replacement module 260) the second item for replacing the item.

The online system 140 may compare (e.g., via the item replacement module 260) the perception score to a threshold score. Responsive to the perception score being above the threshold score, the online system 140 may generate (e.g., via the item replacement module 260) a replacement cost related to a cost of replacing the item with the second item, and the online system 140 may generate (e.g., via the item replacement module 260) an appeasement cost related to a cost of appeasement of the user due to the user complaining about the expiration date of the item. The online system 140 may compare (e.g., via the item replacement module 260) the replacement cost to the appeasement cost. Responsive to the replacement cost being less than the appeasement cost, the online system 140 may identify (e.g., via the item replacement module 260) the second item for replacing the item.

The online system 140 generates 425 (e.g., via the content presentation module 210), using the information about the item and information about the second item, a user interface signal. The online system 140 sends 430 (e.g., via the content presentation module 210), via the network, the user interface signal to the device associated with the user or the device associated with the servicing agent, wherein the sending the user interface signal causes the device associated with the user or the device associated with the servicing agent to display a user interface with a notification about the expiration date of the item and a recommendation for replacing the item in the order with the second item.

The online system 140 may receive, via the network and from a device associated with a source (e.g., the source computing system 120), source data including information about expiration dates for a collection of items of a plurality of item types at the source converted by a plurality of users of the online system 140. The online system 140 may apply, for each user of the plurality of users, the perception prediction machine-learning model (e.g., via the perception prediction module 250) to a portion of the source data related to each user and information about each user to generate a set of perception scores for each user and a corresponding item type of the plurality of item types, wherein each perception score from the set of perception scores is indicative of a likelihood that each user will perceive a respective expiration date from a set of expiration dates of the corresponding item type as unacceptable. The online system 140 may compare (e.g., via the aggregation module 270), for each user, each perception score from the set of perception scores to a threshold likelihood to identify a highest perception score among a subset of one or more perception scores from the set of perception scores that are less than the threshold likelihood. The online system 140 may identify (e.g., via the aggregation module 270), for each user and the corresponding item type, a minimum acceptable expiration date from the set of expiration dates that corresponds to the highest perception score among a subset of one or more perception scores. The online system 140 may aggregate (e.g., via the aggregation module 270) minimum acceptable expiration dates across the plurality of users for each item type of the plurality of item types to generate a respective aggregated minimum acceptable expiration date of a plurality of aggregated minimum acceptable expiration dates for the plurality of item types at the source. The online system 140 may generate (e.g., via the aggregation module 270), using information about the plurality of aggregated minimum acceptable expiration dates for the plurality of item types, a source reporting signal. The online system 140 may send (e.g., via the aggregation module 270), via the network to the device associated with the source, the source reporting signal including information about the plurality of aggregated minimum acceptable expiration dates for the plurality of item types at the source.

The online system 140 may retrieve (e.g., via the machine-learning training module 230), from the database, appeasement data for a collection of users of the online system 140 in relation to expiration dates of a collection of item types delivered to the collection of users. The online system 140 may generate (e.g., via the machine-learning training module 230) a plurality of labels for training data, each of the plurality of labels including an indication about an appeasement for a corresponding item type of the collection of item types and an indication about a time duration until a corresponding expiration date of the corresponding item type. The online system 140 may train (e.g., via the machine-learning training module 230), using the training data including the plurality of labels, the perception prediction machine-learning model to generate a set of initial values for a set of parameters of the perception prediction machine-learning model.

The online system 140 may collect (e.g., via the machine-learning training module 230) feedback data with information about an action performed by the user in response to the notification about the expiration date of the item and the recommendation for replacing the item in the order with the second item. The online system 140 may re-train the perception prediction machine-learning model by updating (e.g., via the machine-learning training module 230), using the feedback data, a set of parameters of the perception prediction machine-learning model.

Embodiments of the present disclosure are directed to the online system 140 that utilizes a trained machine-learning model to predict a perception of a user of the online system 140 about an expiration date of an item. The machine-learning model is trained to predict a likelihood that the user will complain about an item's expiration date. The machine-learning model may be utilized to trigger the replacement flow for the item having a perceived “too soon” expiration date. Additionally, the machine-learning model may be deployed across a sample set of users to determine minimum expiration dates for different items at a source location.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a network and from a device associated with a user of an online system or a device associated with a servicing agent who is servicing an order placed by the user at the online system, an item signal including information about an expiration date of an item in the order;
responsive to receiving the item signal, accessing a perception prediction machine-learning model of the online system, wherein the perception prediction machine-learning model is trained to predict a likelihood that the user will perceive the expiration date of the item as unacceptable;
applying the perception prediction machine-learning model to the item signal, information about the user, and information about the item to generate a perception score that is indicative of the likelihood that the user will perceive the expiration date of the item as unacceptable;
identifying, based at least in part on the perception score and the information about the item, a second item for replacing the item, the second item having a second expiration date that is later than the expiration date of the item;
generating, using the information about the item and information about the second item, a user interface signal; and
sending, via the network, the user interface signal to the device associated with the user or the device associated with the servicing agent, wherein the sending the user interface signal causes the device associated with the user or the device associated with the servicing agent to display a user interface with a notification about the expiration date of the item and a recommendation for replacing the item in the order with the second item.

2. The method of claim 1, further comprising:
receiving, via the network and from a device associated with a source, source data including information about expiration dates for a collection of items of a plurality of item types at the source converted by a plurality of users of the online system;
applying, for each user of the plurality of users, the perception prediction machine-learning model to a portion of the source data related to each user and information about each user to generate a set of perception scores for each user and a corresponding item type of the plurality of item types, wherein each perception score from the set of perception scores is indicative of a likelihood that each user will perceive a respective expiration date from a set of expiration dates of the corresponding item type as unacceptable;
comparing, for each user, each perception score from the set of perception scores to a threshold likelihood to identify a highest perception score among a subset of one or more perception scores from the set of perception scores that are less than the threshold likelihood;
identifying, for each user and the corresponding item type, a minimum acceptable expiration date from the set of expiration dates that corresponds to the highest perception score among a subset of one or more perception scores; and
aggregating minimum acceptable expiration dates across the plurality of users for each item type of the plurality of item types to generate a respective aggregated minimum acceptable expiration date of a plurality of aggregated minimum acceptable expiration dates for the plurality of item types at the source.

3. The method of claim 2, further comprising:
generating, using information about the plurality of aggregated minimum acceptable expiration dates for the plurality of item types, a source reporting signal; and
sending, via the network to the device associated with the source, the source reporting signal including information about the plurality of aggregated minimum acceptable expiration dates for the plurality of item types at the source.

4. The method of claim 1, wherein receiving the item signal comprises:
gathering, via one or more cameras mounted to the device associated with the user being a physical cart operated by the user in a source location, image data related to the item;
receiving, from the physical cart and via the network, the image data; and
extracting, from the image data, the expiration date of the item to obtain the item signal including the information about the expiration date of the item.

5. The method of claim 1, wherein receiving the item signal comprises:
receiving, from the device associated with the servicing agent and via the network, scanning data generated by scanning the item via the device associated with the servicing agent; and
extracting, from the scanning data, the expiration date of the item to obtain the item signal including the information about the expiration date of the item.

6. The method of claim 1, wherein receiving the item signal comprises:
receiving, from the device associated with the servicing agent and via the network, image data related to the item captured by a camera of the device associated with the servicing agent; and
extracting, from the image data, the expiration date of the item to obtain the item signal including the information about the expiration date of the item.

7. The method of claim 1, further comprising:
retrieving, from a database of the online system, message threads related to chats of the user; and
generating the information about the user by parsing the message threads to extract portions of the message threads related to at least one of expiration dates of the item or expiration dates of one or more other items of a same type as the item, the information about the user including the extracted portions of the message threads.

8. The method of claim 1, further comprising:
gathering, via sensors mounted to physical carts operated by the user in source locations, sensor data including information about a first set of expiration dates of a first set of items placed to the physical carts and later replaced by a second set of items having a second set of expiration dates;
receiving, from the physical carts and via the network, the sensor data;
storing, in a database of the online system, the sensor data; and
retrieving, from the database, the sensor data to generate the information about the user including the sensor data.

9. The method of claim 1, further comprising:
retrieving, from a database of the online system and using an identifier of the item, the information about the item including information about a type of the item and information about historical appeasements related to expirations of the item.

10. The method of claim 1, wherein identifying the second item comprises:
comparing the perception score to a threshold score; and
responsive to the perception score being above the threshold score, identifying the second item for replacing the item.

11. The method of claim 1, wherein identifying the second item comprises:
comparing the perception score to a threshold score;
responsive to the perception score being above the threshold score:
generating a replacement cost related to a cost of replacing the item with the second item, and
generating an appeasement cost related to a cost of appeasement of the user due to the user complaining about the expiration date of the item;
comparing the replacement cost to the appeasement cost; and
responsive to the replacement cost being less than the appeasement cost, identifying the second item for replacing the item.

12. The method of claim 1, further comprising:
retrieving, from a database of the online system, appeasement data for a collection of users of the online system in relation to expiration dates of a collection of item types delivered to the collection of users;
generating a plurality of labels for training data, each of the plurality of labels including an indication about an appeasement for a corresponding item type of the collection of item types and an indication about a time duration until a corresponding expiration date of the corresponding item type; and
training, using the training data including the plurality of labels, the perception prediction machine-learning model to generate a set of initial values for a set of parameters of the perception prediction machine-learning model.

13. The method of claim 1, further comprising:
collecting feedback data with information about an action performed by the user in response to the notification about the expiration date of the item and the recommendation for replacing the item in the order with the second item; and
re-training the perception prediction machine-learning model by updating, using the feedback data, a set of parameters of the perception prediction machine-learning model.

14. A computer program product comprising a non-transitory computer readable storage medium having instructions encoded thereon that, when executed by a processor, cause the processor to perform steps comprising:
receiving, via a network and from a device associated with a user of an online system or a device associated with a servicing agent who is servicing an order placed by the user at the online system, an item signal including information about an expiration date of an item in the order;
responsive to receiving the item signal, accessing a perception prediction machine-learning model of the online system, wherein the perception prediction machine-learning model is trained to predict a likelihood that the user will perceive the expiration date of the item as unacceptable;
applying the perception prediction machine-learning model to the item signal, information about the user, and information about the item to generate a perception score that is indicative of the likelihood that the user will perceive the expiration date of the item as unacceptable;
identifying, based at least in part on the perception score and the information about the item, a second item for replacing the item, the second item having a second expiration date that is later than the expiration date of the item;
generating, using the information about the item and information about the second item, a user interface signal; and
sending, via the network, the user interface signal to the device associated with the user or the device associated with the servicing agent, wherein the sending the user interface signal causes the device associated with the user or the device associated with the servicing agent to display a user interface with a notification about the expiration date of the item and a recommendation for replacing the item in the order with the second item.

15. The computer program product of claim 14, wherein the instructions further cause the processor to perform steps comprising:
receiving, via a network and from a device associated with a source, source data including information about expiration dates for a collection of items of a plurality of item types at the source converted by a plurality of users of the online system;
applying, for each user of the plurality of users, the perception prediction machine-learning model to a portion of the source data related to each user and information about each user to generate a set of perception scores for each user and a corresponding item type of the plurality of item types, wherein each perception score from the set of perception scores is indicative of a likelihood that each user will perceive a respective expiration date from a set of expiration dates of the corresponding item type as unacceptable;
comparing, for each user, each perception score from the set of perception scores to a threshold likelihood to identify a highest perception score among a subset of one or more perception scores from the set of perception scores that are less than the threshold likelihood;
identifying, for each user and the corresponding item type, a minimum acceptable expiration date from the set of expiration dates that corresponds to the highest perception score among a subset of one or more perception scores;
aggregating minimum acceptable expiration dates across the plurality of users for each item type of the plurality of item types to generate a respective aggregated minimum acceptable expiration date of a plurality of aggregated minimum acceptable expiration dates for the plurality of item types at the source;
generating, using information about the plurality of aggregated minimum acceptable expiration dates for the plurality of item types, a source reporting signal; and
sending, via the network to the device associated with the source, the source reporting signal including information about the plurality of aggregated minimum acceptable expiration dates for the plurality of item types at the source.

16. The computer program product of claim 14, wherein the instructions further cause the processor to perform steps comprising:
gathering, via one or more cameras mounted to the device associated with the user being a physical cart operated by the user in a source location, image data related to the item;
receiving, from the physical cart and via the network, the image data; and
extracting, from the image data, the expiration date of the item to obtain the item signal including the information about the expiration date of the item.

17. The computer program product of claim 14, wherein the instructions further cause the processor to perform steps comprising:
receiving, from the device associated with the servicing agent and via the network, image data related to the item captured by a camera of the device associated with the servicing agent; and
extracting, from the image data, the expiration date of the item to obtain the item signal including the information about the expiration date of the item.

18. The computer program product of claim 14, wherein the instructions further cause the processor to perform steps comprising:
gathering, via sensors mounted to physical carts operated by the user in source locations, sensor data including information about a first set of expiration dates of a first set of items placed to the physical carts and later replaced by a second set of items having a second set of expiration dates;
receiving, from the physical carts and via the network, the sensor data;
storing, in a database of the online system, the sensor data; and
retrieving, from the database, the sensor data to generate the information about the user including the sensor data.

19. The computer program product of claim 14, wherein the instructions further cause the processor to perform steps comprising:
retrieving, from a database of the online system, appeasement data for a collection of users of the online system in relation to expiration dates of a collection of item types delivered to the collection of users;
generating a plurality of labels for training data, each of the plurality of labels including an indication about an appeasement for a corresponding item type of the collection of item types and an indication about a time duration until a corresponding expiration date of the corresponding item type;
training, using the training data including the plurality of labels, the perception prediction machine-learning model to generate a set of initial values for a set of parameters of the perception prediction machine-learning model;
collecting feedback data with information about an action performed by the user in response to the notification about the expiration date of the item and the recommendation for replacing the item in the order with the second item; and
re-training the perception prediction machine-learning model by updating, using the feedback data, the set of parameters of the perception prediction machine-learning model.

20. A computer system comprising:
a processor; and
a non-transitory computer-readable storage medium having instructions that, when executed by the processor, cause the computer system to perform steps comprising:
receiving, via a network and from a device associated with a user of an online system or a device associated with a servicing agent who is servicing an order placed by the user at the online system, an item signal including information about an expiration date of an item in the order;
responsive to receiving the item signal, accessing a perception prediction machine-learning model of the online system, wherein the perception prediction machine-learning model is trained to predict a likelihood that the user will perceive the expiration date of the item as unacceptable;
applying the perception prediction machine-learning model to the item signal, information about the user, and information about the item to generate a perception score that is indicative of the likelihood that the user will perceive the expiration date of the item as unacceptable;
identifying, based at least in part on the perception score and the information about the item, a second item for replacing the item, the second item having a second expiration date that is later than the expiration date of the item;
generating, using the information about the item and information about the second item, a user interface signal; and
sending, via the network, the user interface signal to the device associated with the user or the device associated with the servicing agent, wherein the sending the user interface signal causes the device associated with the user or the device associated with the servicing agent to display a user interface with a notification about the expiration date of the item and a recommendation for replacing the item in the order with the second item.
